(19) United States
(12) Patent Application Publication
(10) Pub. No.: US 2025/0324972 A1
(43) Pub. Date: Oct. 23, 2025

(54) METHOD OF CONTROLLING NEMATODES

(71) Applicant: ADAMA MAKHTESHIM LTD., Beer Sheva (IL)

(72) Inventors: Bruno VENTURA LOVATO, Schaffhausen (CH); Shrikant GANESH GURAV, Loni Kalbhor (IN); Norberto LUIZ DE OLIVEIRA NETO, Londrina (BR)

(73) Assignee: ADAMA MAKHTESHIM LTD., Beer Sheva (IL)

(21) Appl. No.: 18/870,951

(22) PCT Filed: May 31, 2023
(86) PCT No.: PCT/IL2023/050558

§ 371 Date: Dec. 2, 2024

(30) Foreign Application Priority Data
Jun. 2, 2022 (IN) 202211031741

(51) Int. Cl. A01N 43/78; A01P 5/00

(52) U.S. Cl. CPC A01N 43/78; A01P 5/00

(57) ABSTRACT

The invention relates to a method of protecting a plant against a nematode attack, comprising initiating application of fluensulfone to the soil or growth medium on the time of planting/transplanting or later.

### BACKGROUND

Nematodes (order Tylenchida), include many plant-parasitic nematodes that are active, flexible, elongate organisms living on moist surfaces or in liquid environments, including films of water within soil and moist tissues within other organisms. There are numerous plant-parasitic nematode species, including various cyst nematodes (e.g., Heterodera sp.), root knot nematodes (e.g., Meloidogyne sp.), lesion nematodes (e.g., Pratylenchus sp.), dagger nematodes (e.g., Xiphinema sp.) and stem and bulb nematodes (e.g., Ditylenchus sp.), among others.

Nematode species grow through a series of lifecycle stages and molts. Typically, there are five stages and four molts: egg stage; first juvenile stage—J1; first molt—M1; second juvenile stage, sometimes hatch from egg-J2; M2; J3; M3; J4; M4; and adult-A. Juvenile (“J”) stages are also sometimes referred to as larval (“L”) stages.

Nematode parasites of plants can inhabit all parts of plants, including roots, developing flower buds, leaves, and stems. Plant parasites are classified on the basis of their feeding habits into the broad categories of migratory ectoparasites, migratory endoparasites, and sedentary endoparasites. Sedentary endoparasites, which include the root knot nematodes (Meloidogyne) and cyst nematodes (Globodera and Heterodera) induce feeding sites (“syncytia”) and establish long-term infections within roots that are often very damaging to crops.

Thus, root-knot nematodes are a collective denomination of a variety of pests affecting the roots of various agricultural and horticultural plants. Soil infestation with these nematodes leads to root galling, a situation when nematode juveniles penetrate the root and colonize it, thereby impairing the physiological function of the roots, and may in extreme cases lead to root complete degradation and plant death. A standard system for root galling rating has been in use since the 1980s and is known as galling severity index, a number between zero and 10, with zero being represented by a clean root with no knots, and ten being severely knotted roots with no functional roots, as shown in detail below.

Chemical control of soilborne pathogens, e.g. nematodes, is achieved by application of fumigants to the soil (gases, or compounds releasing gases when exposed to soil moisture) or non-fumigant compounds. As to the application of non-fumigant nematicides, one prominent nematicide is fluensulfone:

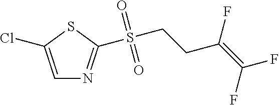 [SMILES: O=S(=O)(CCC(F)=C(F)F)c1ncc(Cl)s1]

[chemical name 5-chloro-2-(3,4,4-trifluoro-but-3-ene-1-sulfonyl)-1,3-thiazole]. Fluensulfone exhibits irreversible and rapid nematocidal activity. Upon application on the soil surface, fluensulfone moves down and reaches the rhizosphere. The material is very potent and even when diluted in the soil solution at very low concentrations, it can intoxicate nematode juveniles and eggs. Juveniles are permanently paralyzed, whereas eggs lose the ability to hatch. Additionally, fluensulfone does not only act as a direct nematicide in the soil, but it is also active as a systemic molecule after plant uptake, and remains active in the roots, protecting them against nematode attack. Fluenosulfone was shown to have true nematocidal activity, rather than temporary nematistatic (immobilizing) activity [Oka et al., Pest Manag Sci 2012 68:268-275].

Nematicides are often applied prior to sowing or transplanting of the crops, e.g., by being rototilled into the soil during the preparation of the growth bed or the field plots, or delivered through drip irrigation lines on the prepared beds several days before saplings are transplanted or seeds are sown. That is, it is customary to apply nematicides at least once before planting.

In a recently published paper, Giannakou et al. [(2019) Cogent Food & Agriculture, 5:1, Article 1643819, DOI: 10.1080/23311932.2019.1643819.] reported of the results application of fluensulfone seven day before transplanting on tomato cultivated in a greenhouse. Application of fluensulfone on cucumber plants was also studied (seven days before planting, followed by a second application fifteen days after planting).

### THE INVENTION

We evaluated the performance of fluensulfone in a field trial, at varying application rates initiated on different times, i.e., studying the effects of various preplant and post-plant application programs. Reference nematicides (e.g., carbofuran and fluopyram) were also included in the study. The results of the field trial reported below show the efficiency of fluensulfone application as part of a nematode management program, initiated on the day of planting/transplanting.

Hereinafter, the phrase “application of fluensulfone initiated on the time of planting/sowing/transplanting or later” and the like refers to a application of fluensulfone, for example, by the following methods:
1) Single application of fluensulfone on the day of planting/transplanting (designated herein DAT=0); or
2) Application of fluensulfone on the day of planting/transplanting (DAT=0) followed by a subsequent application of fluensulfone n days later (designated herein DAT=n, e.g., 1≤n≤50, 1≤n≤30, e.g., 7≤n≤30).
3) Application of fluensulfone initiated at DAT=n, e.g., 1≤n≤7, optionally followed by one or more application of fluensulfone.

Hereinafter we use the notations AR¹ and AR² to indicate the application rates according to the first and second control programs, with a subscript marking the day of application measured by DAT, i.e., AR¹_{DAT=0}; AR²_{DAT=0} and AR²_{DAT=n}. For example, application of fluensulfone formulated as emulsifiable concentrate (480 g/L EC) initiated on the day of planting/transplanting/seeding, especially with AR¹_{DAT=0} or (AR²_{DAT=0}+AR²_{DAT=n}) of not less than 50 ml/ha, e.g., up to 2000 ml/ha, for example, from 250 ml/ha to 1500 ml/ha, e.g., from 500 to 1000 ml/ha, were both shown to be very effective, outperforming preplant fluensulfone application at comparable dose. Not only that delaying the application of fluensulfone caused no phytotoxic effect, but the overall performance of fluensulfone applied according to the approach described above was significantly better versus pre-plant application scheme in terms of nematode damage reduction on the roots. The extent of galling on the root was assessed based on the root-knot charting rate described by Bridge and Page [Tropical Pest Management 26(3) 296-298 (1980), appended herein as FIG. 1. The rating method is based on assigning an integer number in the interval from 0 (no knots on the roots) to 10 (all roots severely knotted indicative of plant death). The average root galling indexes (RGI) determined periodically in the field trials during the test period, for the treatments based on initiating application of fluensulfone on the day of planting/transplanting, surprisingly low relative to other treatments, as they were below 3 even seventy days after planting/transplanting. That is, the method of the invention restrains root galling index at below 3, and even at below 2, at least over 50 days and even 75 days after planting.

As shown by the experimental results reported below, application of fluensulfone initiated on the time of sowing/transplanting provided significant reduction of root damage also in comparison to reference nematicides. Not only the better efficiency of fluensulfone is observed, but also this effect is achieved with reasonably moderate application rates. Annual plants could benefit from an in-season application of fluensulfone on initiated the day of planting/sowing/transplanting.

Accordingly, the invention is primarily directed to a method of protecting a plant (for example, an annual plant, e.g., vegetables) against a nematode attack, comprising initiating application of fluensulfone to the soil or growth medium on the time of planting/transplanting, or later.

For example, fluensulfone can be applied formulated in a liquid. One useful type of liquid formulation of fluensulfone is an emulsifiable concentrate (e.g., from 100 to 600 g/L, e.g., 350 to 500 g/Liter fluensulfone, e.g., from 400 to 480 g/Liter, dissolved in an organic solvent, e.g., a hydrocarbon, including petroleum distillates, such as the commercially available products Nimitz® 400 and Nimitz® 480 EC). Other examples that can be considered include oil-in-water emulsion and suspension. Solid formulations of fluensulfone, such as granular fluensulfone, is also suitable for use in the invention.

The method of the invention can be used for control and suppression of nematodes in crops that belong to various families and genera, such as solanaceous (e.g., tomato, pepper, potatoes, and eggplant), cucurbitaceous (e.g., cucumber, squash, and melon), brassicaceous (e.g., broccoli and cabbage), rosaceous (e.g., strawberry), asteraceous (e.g., lettuce), and others, including turf grasses. Vegetables of the Fruiting Vegetables Group (Crop Group 8-10), e.g., tomato, could especially benefit from the nematode control programs initiated on the day of planting/transplanting as described herein.

The method is applicable for all relevant plant parasitic nematodes that attack plant roots such as, e.g., Belonolaimus, Globodera, Hoplolaimus, Meloidogyne, and Pratylenchus. A List of relevant plant parasitic nematode species includes: Belonolaimus gracilis, Belonolaimus longicaudatus, Belonolaimus spp., Cactodera amaranthi, Cactodera betulae, Cactodera cacti, Cactodera estonica, Cactodera thornei, Cactodera weissi, Criconema civellae, Criconema decalineatum, Criconema spinalineatum, Criconemella spp., Criconemoides citri, Criconemoides simile, Criconemoides spp., Cryphodera eucalypti, Dolichodorus heterocephalous, Dolichodorus spp., Dorylaimus spp., Globodera achilleae, Globodera mali, Globodera millefolii, Globodera pallida, Globodera rostochiensis, Globodera spp., Globodera tabacum, Globodera tabacum solanacearum Globodera tabacum virginiae, Helicotylenchus africanus, Helicotylenchus dihystera, Helicotylenchus erythrinae, Helicotylenchus multicinctus, Helicotylenchus pseudorobustus, Helicotylenchus seinhorsti, Helicotylenchus spp., Hemicriconemoides biformis, Hemicriconemoides floridensis, Hemicriconemoides spp., Hemicriconemoides wessoni, Hemicycliophora parvana, Hemicycliophora similis, Hemicycliophora spp., Heterodera schachtii, Heterodera amygdali, Heterodera avenae, Heterodera cajani, cardiolata, Heterodera carotae, Heterodera cruciferae, Heterodera cyperi, Heterodera elachista, Heterodera fici, Heterodera galeopsidis, Heterodera glycines, Heterodera goettingiana, Heterodera gradunim, Heterodera hordecalis, Heterodera humuli, Heterodera latipons, Heterodera lespedezae, Heterodera longicolla, Heterodera major, Heterodera medicaginis, Heterodera mothi, Heterodera oryzae, Heterodera oxiana, Heterodera rosii, Heterodera rumicis, Heterodera sacchari, Heterodera salixophila, Heterodera schachtii, Heterodera scleranthii, Heterodera sonchophila, Heterodera spp., Heterodera tadshikistanica, Heterodera trifolii, Heterodera turcomanica, Heterodera urticae, Heterodera ustinovi, Heterodera vigni, Heterodera zeae, Hirschmanniella oryzae, Hirschmanniella spp., Hoplolaimus galeatus, Hoplolaimus columbus, Hoplolaimus galeatus, Hoplolaimus spp., Hoplolaimus tylenchiformis, Hypsoperine graminis, Ibipora lolii, Longidorus spp., Longidorus sylphus, Meloidodera floridensis, Meloidodera spp., Meloidodera tadshikistanica, Meloidoderita spp., Meloidogyne acronea, Meloidogyne arenaria, Meloidogyne artiellia, Meloidogyne brevicauda, Meloidogyne camelliae, Meloidogyne carolinensis, Meloidogyne chitwoodi, Meloidogyne enterolobii, Meloidogyne ethiopica, Meloidogyne exigua, Meloidogyne graminicola, Meloidogyne graminus, Meloidogyne hapla, Meloidogyne hispanica, Meloidogyne incognita, Meloidogyne incognita acrita, Meloidogyne indica, Meloidogyne inornata, Meloidogyne javanica, Meloidogyne kikuyuensis, Meloidogyne konaensis, Meloidogyne mali, Meloidogyne microtyla, Meloidogyne nassi, Meloidogyne ovalis, Meloidogyne paranaensis, Meloidogyne platani, Meloidogyne querciana, Meloidogyne sasseri, Meloidogyne spp., Meloidogyne tadshikistanica, Meloidogyne thamesi, Mesoanguina picridis, Mesocriconema spp., Nacobbodera chitwoodi, Nacobbus batatiformis, Nacobbus spp., Panagrellus redivivus, Panagrellus silusiae, Paralongidorus spp., Paratrichodorus minor, Paratrichodorus spp., Paratylenchus curvitatus, Paratylenchus dianthus, Paratylenchus elachistus, Paratylenchus hamatus, Paratylenchus spp., Pratylenchus brachyurus, Pratylenchus coffeae, Pratylenchus goodeyi, Pratylenchus jaehni, Pratylenchus leiocephalus, Pratylenchus loosi, Pratylenchus musicola, Pratylenchus neglectus Pratylenchus penetrans, Pratylenchus pratensis, Pratylenchus scribneri, Pratylenchus spp., Pratylenchus thornei, Pratylenchus vulnus, Pratylenchus zeae, Pterotylenchus cecidogenus, Punctodera punctata, Radopholus citrophilus, Radopholus oryzae, Radopholus similis, Radopholus spp., Rhadinaphelenchus cocophilus, Rotylenchulus reniformis, Rotylenchulus spp., Rotylenchus buxophilus, Rotylenchus christiei, Rotylenchus spp., Rotylenchus uniformis, Scutellonema blaberum, Scutellonema brachyurum, Scutellonema bradys, Scutellonema christiei, Scutellonema spp., Subanguina radicicola, Thecavermiculatus andinus, Trichodorus christiei, Trichodorus kurumeensis, Trichodorus pachydermis, Trichodorus primitivus, Trichodorus spp., Turbatrix aceti, Tylenchorhynchus claytoni, Tylenchorhynchus martini, Tylenchorhynchus spp., Tylenchulus semipenetrans, Tylenchulus spp. Xiphinema Americanum, Xiphinema chambersi, Xiphinema diversicaudatum, Xiphinema index, Xiphinema nigeriense, Xiphinema radicicola and Xiphinema spp.

The soil wherein the plants are planted may be of varying type and composition. The soil may be prepared for cultivation, e.g., by plowing, tilling, harrowing, and other techniques known to the skilled artisan. The soil may be arranged in cultivation beds, and may contain a variety of micro-irrigation system components, e.g., to effect drip irrigation.

Planting of the plants may be performed as generally known in the art, e.g., by sowing treated or untreated seeds, or by transplanting seedlings of a predetermined age. Initiation of the application of Fluensulfone at the time of planting/transplanting (DAT=0), is usually within 1 to 24 hours after planting/transplanting. Additionally, fluensulfone may also be applied during the crop cycle. For example, when the crop is tomato, fluensulfone may be applied on the day of planting/transplanting, and during the first months of crop establishment, when usually plants are more susceptible to soil pathogens that limit the development of the root system and its function. Depending on the potential damage of a nematode species or its population level, it may require an additional protection to the crops in order to keep the root system health for longer period of time resulting in better conditions for the plant to produce.

Fluensulfone is commercially offered in emulsifiable concentrate and granular formulations at 480 grams active ingredient/liter and 20 grams active ingredient/kilogram, respectively. AR¹_{DAT=0}, or the total of the separately applied doses (AR²_{DAT=0}+AR²_{DAT=n}) is preferably about 25 to 1500 g (for example, from 50 to 1000 g; from 50 to 700 g, e.g., from 100 to 500 g, for example 100 to 300 g, e.g., 100 to 250 g) of fluensulfone per hectare. For example, in case of EC formulation available on the marketplace, suitable application rates AR¹_{DAT=0} or (AR²_{DAT=0}+AR²_{DAT=n}) of not less than 50 ml/ha of a 350 to 500 g/Liter EC formulation, and up to 2000 ml/ha, can be used, such as from 100 to 1200 ml/ha, for example 100 to 1000 ml/ha, e.g., 100 to 600 or 100 to 500 ml/ha. The application rate is usually determined based on the crop, nematode species and its/their population in the soil. For tomato, for example, the experimental results indicate that low application rates AR¹_{DAT=0} or (AR²_{DAT=0}+AR²_{DAT=n}) were effective, e.g., up to 1000 g ai/ha, e.g., in the range of 50 to 500 g ai/ha, such as 50 to 300 g ai/ha, 50 to 250 g ai/ha, or 100 to 500 g ai/ha, e.g., 200 to 500 g ai/ha.

With respect to the second control program, good results are achieved when AR²_{DAT=0} and AR²_{DAT=n} are about the same, i.e., the total amount of fluensulfone supplied to the soil is roughly equally divided between the application on the day of planting/transplantation (AR²_{DAT=0}) and the post-plant application (AR²_{DAT=n}), such that the ratio AR²_{DAT=0}:AR²_{DAT=n} is from 7:5 to 5:7, e.g., 6:5 to 5:6, e.g., around 1:1. However, other proportions are also effective, though it is generally preferred that at least 30% of the total amount of the active compound be delivered to the soil at the day of planting/transplanting.

Fluensulfone can be applied as broadcast soil application, band application, in-furrow, drench and through different irrigation systems by mixing the formulated product in water from 50 to 100,000 L per hectare, depending on the application method. Drip irrigation and soil drenching are the preferred methods.

As mentioned above a solid agricultural fluensulfone formulation can be used, e.g., a granular formulation such as the commercial fluensulfone 2% GR. One preferred mode of applying the granular fluensulfone to the soil is by evenly spreading the granules around each plant, e.g., equidistantly from the plant, namely, in a ring fashion along a circumference of a circle encircling the plant, spaced a few centimeters apart from the plant. Following the application of the granular material, normal irrigation is resumed.

### IN THE DRAWINGS

FIG. 1 is rating chart reproduced from Bridge and Page (supra) for assessment of root-knot nematode levels.

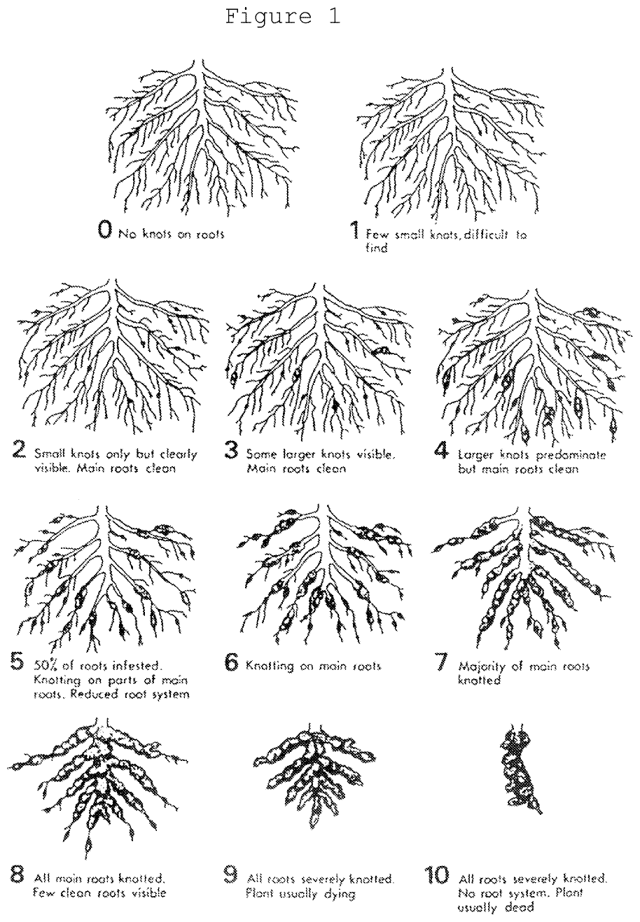

### EXAMPLES

### Example 1—A Field Trial

### Experimental Protocol

An open field trial was conducted. Tomatoes of Aryman variety was used. The soil type was sandy loam.

Fertilizers were applied prior to bed formation. Plots were formed, with a total area of 25 m² per plot. Drip lines were laid in the plot beds (plot beds occupy half the field). Treatments were arranged in a randomized complete block design with two replications.

Fluensulfone emulsifiable concentrate (Nimitz® 480 EC) was used for the fluensulfone treatments. Additionally, comparative nematicides fluopyram (as Fluopyram® 500 SC) and carbofuran (as Carbofuran® 3% CG), were tested. Untreated control plots were formed for comparison.

The design of the trials is tabulated in Table 1. In Table 1, time of application is expressed by DAT, which indicates the number of days relative to the date of planting.

TABLE 1

| | | | | Dose/m² | | | |
|---|---|---|---|---|---|---|---|
| No | Treatment | Timing | | (treated area of bed) | | Dose/ha* | |
| 1 | Control | NA | | NA | | — | |
| 2 | Nimitz ® 480 EC | 0 | DAT | 1^{st}: 0.05 ml | | 250 | ml |
| | | 25 | DAT | 2^{nd}: 0.05 ml | | 250 | ml |
| 3 | Nimitz ® 480 EC | 0 | DAT | 1^{st}: 0.1 ml | | 500 | ml |
| | | 25 | DAT | 2^{nd}: 0.1 ml | | 500 | ml |
| 4 | Nimitz ® 480 EC | 0 | DAT | 0.1 | ml | 500 | ml |
| 5 | Nimitz ® 480 EC | 0 | DAT | 0.2 | ml | 1000 | ml |
| 6 | Nimitz ® 480 EC | −5 | DAT | 0.1 | ml | 500 | ml |
| 7 | Nimitz ® 480 EC | −5 | DAT | 0.2 | ml | 1000 | ml |
| 8 | Fluopyram ® | 0 | DAT | 0.0625 | ml/plant | 1250 | ml |
| | 500 SC | | | | | | |
| 9 | Carbofuran ® | −1 to 0 | DAT | 10 | g | 50 | kg |
| | 3% CG | | | | | | |

*the beds occupy half of the field

Treatments 2 and 3 (of the invention): fluensulfone in the form of an emulsifiable concentrate (Nimitz® 480 EC) was applied at the day of planting (DAT=0), followed by a post-plant application twenty five days later (DAT=25). The application method consisted of the following steps. First, the soil was wetted by irrigation water. Then, at the day of planting, appropriate amounts of Nimitz® 480 EC were diluted in water and applied to achieve the application rates tabulated in Table 1. It was repeated on DAT=25.

Treatments 4 and 5 (of the invention): fluensulfone in the form of an emulsifiable concentrate (Nimitz® 480 EC) was applied at the day of planting g (DAT=0). The application method consisted of the following steps. First, the soil was wetted by irrigation with water. Then, at the day of transplantation, appropriate amounts of Nimitz® 480 EC were diluted in water and applied to achieve the application rates tabulated in Table 1.

Treatments nos. 6 and 7 (comparative): fluensulfone in the form of an emulsifiable concentrate (Nimitz® 480 EC) was applied before transplantation (DAT=−5). The application method consisted of the following steps. First, the soil was wetted by irrigation with 100 m³/ha water. 48 hours later, on DAT=−5, appropriate amounts of Nimitz® 480 EC diluted in 80 m³/hectare of water to account for the application rates tabulated in Table 1 were supplied to the soil by drip irrigation. Next, 72 hours later, irrigation lines were flushed with 100 m³/ha of. Seedlings were transplanted 24 hours after a second flushing.

Treatment no. 8 (comparative): fluopyram as suspension concentrate (500 SC) was applied on the day of transplanting. An appropriate amount of the SC formulation was diluted in water such that each plant would receive 100 ml of the diluted solution with the dose indicated in Table 1. The 100 ml solution/per plant was added to the soil by manual soil drenching, at a distance of 8 to 10 cm away from the plant, along a circumference encircling the plant.

Treatment no. 9 (comparative): Carbofuran® 3% CG was applied directly on top of the bed at application rate of 50 kg/hectare (broadcast application). On DAT=−1 to 0, seedlings were transplanted and drip irrigation initiated.

### Results

Phytotoxicity was evaluated on DAT=7, 21, 32, and 46. Phytotoxicity was observed only with fluopyram, giving a score of 65.

Root galling was assessed in the open-field trial, on DAT=25, 50, and 75, using the root galling index. The data is summarized in Table 2. The average galling index, as well as the percentile of the rate of change (ROC) vis-à-vis the control group are presented.

TABLE 2

| | | | 25 DAT | | 50 DAT | | 75 DAT | |
|---|---|---|---|---|---|---|---|---|
| No | Treatment | Timing | RGI | % ROC | RGI | % ROC | RGI | % ROC |
| 1 | Control | NA | 1.80^{a} | 0.00 | 4.60^{a} | 0.00 | 5.50^{a} | 0.00 |
| 2 | N480 EC | 0 DAT & 25 DAT | 0.20^{de} | 88.89 | 1.10^{ef} | 76.09 | 1.30^{def} | 76.36 |
| | | @ 250 ml/ha | | | | | | |
| 3 | N480 EC | 0 DAT & 25 DAT | 0.10^{e} | 94.44 | 0.80^{f} | 82.61 | 0.90^{f} | 83.64 |
| | | @ 500 ml/ha | | | | | | |
| 4 | N480 EC | 0 DAT | 0.20^{de} | 88.89 | 1.20^{ef} | 73.91 | 1.30^{def} | 76.36 |
| | | @ 500 ml/ha | | | | | | |
| 5 | N480 EC | 0 DAT | 0.10^{e} | 94.44 | 1.10^{ef} | 76.09 | 1.10^{ef} | 80.00 |
| | | @ 1000 ml/ha | | | | | | |
| 6 | N480 EC | −5 DAT | 0.30^{cde} | 83.33 | 1.80^{bcd} | 60.87 | 1.90^{bc} | 65.45 |
| | | @ 500 ml/ha | | | | | | |
| 7 | N480 EC | −5 DAT | 0.20^{de} | 88.89 | 1.50^{bcde} | 67.39 | 1.80^{cd} | 67.27 |
| | | @ 1000 ml/ha | | | | | | |
| 8 | Fluopyram | 0 DAT | 0.40^{bcd} | 77.78 | 1.60^{de} | 65.22 | 1.50^{cde} | 72.73 |
| | 500 SC | @ 1250 ml/ha | | | | | | |
| 9 | Carbofuran. | −1 to 0 DAT | 0.60^{b} | 66.67 | 1.90^{b} | 58.70 | 2.40^{b} | 56.36 |
| | 3% CG | @ 50 kg/ha | | | | | | |

### CONCLUSION

Application of fluensulfone initiated at the day of transplantation achieved very good results. No phytotoxicity was observed across the entire range of application rates tested. The application of fluensulfone 480 EC at a dose of 500 ml per hectare at transplanting followed by application of a second equal dose during crop cycle produced very good results in terms of root galling, comparable to the performance of fluensulfone applied once at transplanting at 1000 ml/ha. These two treatment programs emerged victorious. Moreover, other treatment programs initiated at the day of transplanting, involving lower application rates of fluensulfone 480 EC, such as 250 ml/ha applied twice, also produced good results.

1. A method of protecting a plant against a nematode attack, comprising initiating application of fluensulfone to the soil or growth medium on the time of planting/transplanting or later.

2. A method according to claim 1, comprising a single application of fluensulfone on the day of planting/transplanting.

3. A method according to claim 1, comprising a first application of fluensulfone on the day of planting/transplanting and a second, subsequent application.

4. A method according to claim 3, wherein the second application takes place n days after the first application, wherein 7≤n≤30.

5. A method according to any of the preceding claims, wherein fluensulfone is formulated in a liquid.

6. A method according to claim 5, wherein the liquid is an emulsifiable concentrate (EC).

7. A method according to claim 6, wherein the concentration of the EC formulation is from 350 to 500 g/Liter.

8. A method according to claim 7, wherein the liquid formulation is applied at a total application rate of 50 to 2000 ml/ha.

9. A method according to claim 8, wherein the liquid formulation is applied at a total application rate of 250 ml/ha to 1500 ml/ha.

10. A method according to any one of the preceding claims, wherein the plant is an annual plant.

11. A method according to claim 10, wherein the annual plant is a vegetable and the total application rate is from 50 to 1000 ml/ha.

12. A method according to claim 11, wherein the plant is a vegetable of the Fruiting Vegetables Group.

13. A method according to claim 12, wherein the vegetable is a tomato.

14. A method according to claim 13, wherein the total application rate is up to 1000 g ai/ha.

15. A method according to claim 14, wherein the total application rate is in the range of 50 to 500 g ai/ha.
